(19) United States
(12) Patent Application Publication
(10) Pub. No.: US 2008/0131257 A1
(43) Pub. Date: Jun. 5, 2008

(54) SYSTEM AND METHOD FOR REDUCING COLLATERAL TRANSPORT-INDUCED DAMAGE DURING MICROSTRUCTURE PROCESSING

(76) Inventors: Carsten Peters, Dresden (DE); Thomas Werner, Reichenberg (DE); Frank Feustel, Dresden (DE); Kai Frohberg, Niederau (DE)

Correspondence Address: WILLIAMS, MORGAN & AMERSON, 10333 RICHMOND, SUITE 1100, HOUSTON, TX, 77042, US

(21) Appl. No.: 11/756,124

(22) Filed: May 31, 2007

(30) Foreign Application Priority Data
Nov. 30, 2006 (DE) 10 2006 056 621.1

(51) Int. Cl. B65H 1/00; B05D 5/10; G06F 19/00; B65B 33/00

(52) U.S. Cl. 414/806; 427/154; 427/209; 427/401; 700/115

(57) ABSTRACT

By providing a safety material, such as an adhesive foil, the probability for transport-related damage or destruction of substrates caused by broken substrates may be significantly reduced.

### BACKGROUND OF THE INVENTION

1. Field of the Invention

Generally, the present disclosure relates to the field of fabricating microstructures in distributed manufacturing environments, and, more particularly, to the transport and handling of substrates for forming microstructures, such as integrated circuits.

2. Description of the Related Art

Today's global market forces manufacturers of mass-produced products to offer high quality products at a low price. It is thus important to improve yield and process efficiency to minimize production costs. This holds especially true in the field of microstructure fabrication, for instance for manufacturing semiconductor devices, since, in this field, it is essential to combine cutting-edge technology with mass production techniques. It is, therefore, the goal of manufacturers of semiconductors, or generally of microstructures, to reduce the consumption of raw materials and consumables while at the same time improve yield and process tool utilization. The latter aspects are especially important since the equipment required in modern semiconductor facilities is extremely cost-intensive and represents the dominant part of the total production costs. At the same time, the process tools of a semiconductor facility have to be replaced more frequently compared to most other technical fields due to the rapid development of new products and processes, which may also demand correspondingly adapted process tools.

Integrated circuits are typically manufactured in automated or semi-automated facilities, thereby passing through a large number of process and metrology steps to complete the device. The number and the type of process steps and metrology steps a semiconductor device has to go through depends on the specifics of the semiconductor device to be fabricated. For instance, a sophisticated CPU requires several hundred process steps, each of which has to be carried out within specified process margins so as to fulfill the specifications for the device under consideration.

In many process lines for microstructure devices, such as semiconductor facilities, a plurality of different product types are usually manufactured at the same time, such as memory chips of different design and storage capacity, CPUs of different design and operating speed and the like, wherein the number of different product types may even reach a hundred and more in production lines for manufacturing ASICs (application specific ICs). As a consequence, passing the various product types through the plurality of process tools requires a complex scheduling regime to ensure high product quality and achieve a high performance, such as a high overall throughput of the process tools to obtain a maximum number of products per time and per tool investment costs. Hence, the tool performance, especially in terms of throughput, is a very critical manufacturing parameter as it significantly affects the overall production costs of the individual products. Therefore, in the field of semiconductor production, various strategies are practiced in an attempt to optimize the stream of products for achieving a high yield with moderate consumption of raw materials, thereby requiring significant transport activities on the basis of substrates which may have undergone various processes and thus bear microstructure devices in a more or less advanced process state. Frequently, the manufacturing process for the respective microstructure devices may be distributed among two or more manufacturing sites instead of entirely manufacturing the devices in a single facility, thereby increasing the amount of transport activities required, wherein each transport activity may involve the potential for damage or even loss of substrates.

Within production facilities, substrates, typically wafers, are usually handled in groups, called lots, which are, depending on the degree of automation, conveyed within the manufacturing environment by an automated transport system, also referred to as automated material handling system (AMHS), delivering the substrates in corresponding carriers, for example, front opening unified pods (FOUPs) in which the plurality of substrates are stacked and each substrate is horizontally oriented, to so-called load ports of the tools and picking up carriers therefrom that contain previously processed substrates. Thus, the transport process itself may represent an important factor for efficiently scheduling and managing the manufacturing environment, since the time for loading and unloading carriers may take up to several minutes per carrier exchange event and may be subjected to a great variance, which may result in unwanted idle times at specific process tools, thereby reducing the performance thereof. On the other hand, there is an ongoing drive to increase the size of the corresponding substrates in order to enhance process efficiency. For example, in the past, a development from 150-200 mm has occurred, while currently 300 mm is becoming an industrial standard in IC production, with the prospect of 450 mm wafers in the foreseeable future.

Thus, depending on the size and the process stage of the substrates, the break of a substrate within a respective transport carrier may not only result in a loss of the devices formed on the broken substrate but may also damage the remaining substrates in the transport carrier. For example, microstructure devices are frequently processed to a very advanced manufacturing stage, while a next process step, such as dicing the substrates, may be performed in a different site. To this end, a plurality of substrates are arranged in a transport box, wherein the individual substrates are horizontally held in place by appropriate ridges provided in the transport box. Due to thermal and/or mechanical stress or any other environmental influences during transport, a substrate may break and the resulting pieces may hit one or more of the other substrates, thereby causing damage, such as scratches, particle contamination and the like. Since the substrates have already undergone most of the manufacturing processes, a corresponding loss of devices is highly cost-intensive.

A typical situation during transport of substrates usable or used for the fabrication of microstructure devices may be described with reference to FIGS. 1a-1c. FIG. 1a schematically illustrates a cross-sectional view of a transport box or container 150, which is configured to receive a plurality of substrates 100, which may represent substrates having formed thereon microstructure devices, such as integrated circuits and the like, wherein typically the microstructure devices may be in an advanced manufacturing state requiring transport to a different manufacturing site in order to appropriately continue the overall manufacturing sequence. For instance, the substrates 100 may comprise respective integrated circuits that have to be separated into individual chips prior to packaging. Consequently, depending on the size of the individual die areas formed on the substrate 100, several hundred devices or more may be provided per substrate 100, wherein each individual device may have a value of several to several hundred dollars. For convenience, any such microstructure devices are not shown in FIG. 1a. Typically, the individual substrates 100 are supported at the periphery thereof by respective support structures 151 in order to facilitate automatic loading and unloading of the transport containers 150. Furthermore, the transport container 150 may comprise a cover 152 which substantially seals the substrate from environmental influences, such as particles, moisture and the like. During transport of the container 150, depending on the transportation conditions, the substrates 100 may be exposed to various stress conditions, for instance any thermal and/or mechanical stress situations, which may finally result, in combination with any internally existing mechanical stresses, in severe damage of one or more of the substrates 100, which may even result in a complete breakage of the respective substrate. For instance, in FIG. 1a, a mechanical load or any other stress 140 may act on one of the substrates 100, wherein it should be appreciated that the external load 140 may result in a different response of the substrates 100, depending on the substrate-specific conditions, such as the degree of internal stress condition within the transport container 150 and the like. Consequently, when a certain threshold is exceeded, which may be different for each of the substrates 100, breakage of a respective substrate 100 may result, thereby creating a plurality of fragments and particles contaminating the interior of the transport container 150.

FIG. 1b schematically illustrates the respective situation wherein a plurality of fragments 101 may be distributed within the transport container 150, thereby also contaminating other substrates 100, i.e., producing scratches, particles and the like, which may negatively affect the further processing of the intact substrates 100 after arrival at the destination manufacturing site.

FIG. 1c schematically illustrates the transport container 150, wherein the interaction of the fragments 101 with further substrates 100 may result in destroying one or more additional substrates.

Consequently, the breakage of a substrate 100 during the transport may not only result in a significant loss of microstructure devices provided on the broken substrate, but may also result in severe damage or even breakage of other substrates initially not severely affected by the transport-induced stress.

The present disclosure is directed to various methods and devices that may avoid, or at least reduce, the effects of one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the subject matter disclosed herein relates to a technique for significantly reducing the probability for transport-induced damage of substrates, which may be used or which may be usable for the processing of microstructures. For this purpose, the substrates may be prepared to exhibit a reduced probability for creating loose fragments even if severe transport-induced damage may be caused in one or more of the respective substrates. Consequently, by reducing the probability for creating loose fragments, the contamination of the corresponding transport container may be significantly reduced, thereby also reducing the risk for damaging or destroying other substrates that may be present in the transport container. Furthermore, by appropriately preparing the substrate to exhibit a desired safety behavior upon breakage, existing conventional tools and resources may be used with increased efficiency, thereby providing a significantly enhanced overall yield of the transport activities and thus of the overall manufacturing process of the microstructure devices under consideration.

According to one illustrative embodiment disclosed herein, a method comprises transporting a substrate in a transport container from a first manufacturing site to a second manufacturing site, wherein the substrate has a front side and a back side and represents a carrier material for forming microstructure devices in and on the front side. The method further comprises applying an adhesion layer on the back side of the substrate prior to transporting the substrate, wherein the adhesion layer is configured to reduce contamination of the transport container upon transport-related breakage of the substrate.

According to another illustrative embodiment disclosed herein, a method comprises forming a safety material on a substrate used for processing microstructure devices, wherein the safety material is configured to reduce the formation of loose fragments upon breakage of the substrate. Furthermore, the substrate is conveyed from a first manufacturing site to a second manufacturing site.

According to yet another illustrative embodiment disclosed herein, a system for shipping substrates of microstructure devices from a first manufacturing site to a second manufacturing site is provided. The system comprises a load station configured to load one or more substrates into a transport container, wherein the one or more substrates comprise a safety material adapted to reduce contamination of the transport container upon breakage of a substrate. Furthermore, the system comprises a process tool configured to form the safety material on each of the one or more substrates.

### BRIEF DESCRIPTION OF THE DRAWINGS

The disclosure may be understood by reference to the following description taken in conjunction with the accompanying drawings, in which like reference numerals identify like elements, and in which:

FIGS. 1a-1c schematically illustrate cross-sectional views of a transport container during transporting substrates according to a conventional regime, wherein the breakage of one substrate may result in a significant degree of damage of other substrates in the respective transport container;

FIG. 2a schematically illustrates a substrate having formed thereon a safety material for reducing the probability for creating loose fragments upon breakage of the substrate according to illustrative embodiments disclosed herein;

FIG. 2b schematically illustrates a transport container during transport of a plurality of substrates including a respective safety material according to further illustrative embodiments;

FIG. 2c schematically illustrates a transport regime including an appropriate safety material and a transport orientation of the substrates for further reducing the probability of breakage of substrates during transport according to further illustrative embodiments;

FIGS. 3a-3c schematically illustrates cross-sectional views of substrates having formed thereon respective safety materials for reducing contamination of transport containers upon breakage of the substrate according to further illustrative embodiments;

FIG. 4a schematically illustrates a system for transporting substrates with a reduced probability for transport-induced contamination according to illustrative embodiments; and

FIG. 4b schematically illustrates a cross-sectional view of a substrate including a safety material associated with a sensor element for monitoring transport conditions of the substrate according to still further illustrative embodiments disclosed herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

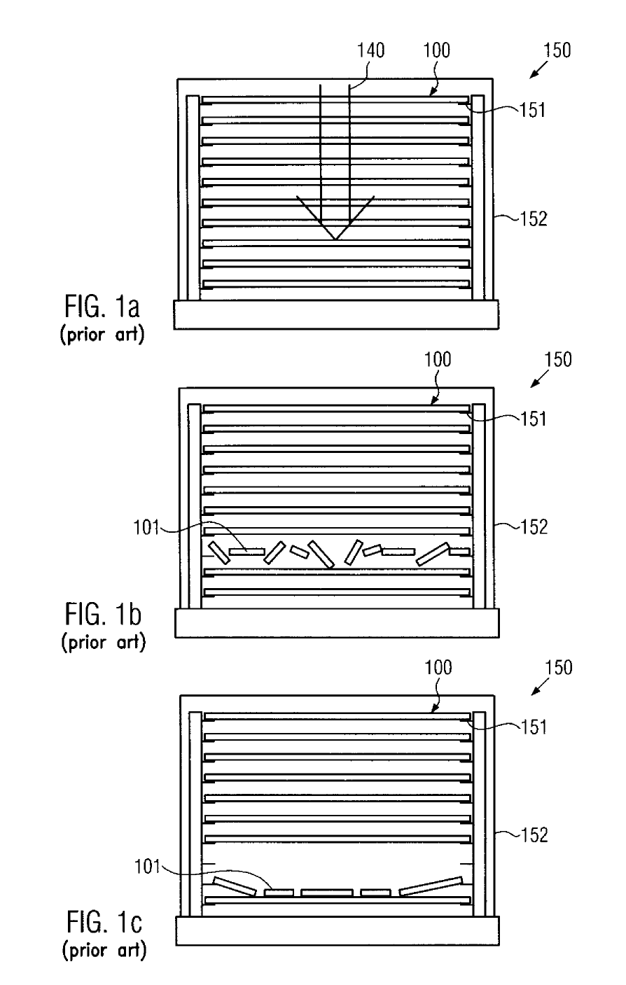

Generally, the subject matter disclosed herein addresses the problem of severe yield reduction during transport or shipping of substrates for the processing of microstructure devices caused by the breakage of one or more substrates during transport. As previously explained, especially during the fabrication of advanced microstructure devices, such as integrated circuits of high complexity and the like, typically a plurality of complex manufacturing processes have to be performed wherein a high number of process activities have to be performed in order to appropriately deliver the substrates to respective manufacturing sites. Although generally certain process modules are configured such that substrate transport may be handled by automated transport systems, thereby significantly reducing the probability of any transport-related undue stress conditions for the substrates, respective microstructure devices may frequently not be completed at one manufacturing site but require at least one transport activity, during which the respective conditions may not be controlled as it would be desirable in order to substantially avoid any transport-related yield losses. For instance, the substrates are typically manufactured in different manufacturing sites and may then be delivered to respective facilities, such as semiconductor fabs and the like, in order to form respective devices on the substrates. Furthermore, some of the highly complex manufacturing processes for completing a separated and packaged semiconductor device may typically be performed in different manufacturing sites due to economic, technical or other reasons. For instance, the process of dicing the respective substrates may be performed at a different manufacturing site compared to the previous processes due to economic reasons with respect to the moderately low degree of automation involved in the dicing process. Since the respective transport conditions during a transport from one manufacturing site to another may be highly variable and may, to a certain degree, be not predictable, typically a compromise is made between economic constraints, i.e., transporting many substrates in a densely packed manner, and the integrity of the respective substrates contained in the respective transport container. Consequently, as previously described with reference to FIGS. 1a-1c, in conventional transport regimes, a significant probability for severe yield losses may exist.

According to the subject matter disclosed herein, respective countermeasures are provided in order to reduce the respective yield losses without substantially contributing to the overall complexity and the manufacturing costs by providing a strategy in which at least the consequences of the breakage of a substrate during transport are significantly reduced. For this purpose, the respective substrates may be prepared prior to actually transporting the substrates in such a way that the probability for creating loose fragments and particles upon breakage of the substrate may be significantly reduced. This may be accomplished on the basis of an appropriately configured safety material that may be formed on appropriate positions of the substrate, wherein the safety material may have a significantly higher degree of flexibility compared to the substrate material so that it may respond to a wide class of external stresses without any significant damage. Furthermore, the safety material may appropriately confine fragments of the broken substrate, for instance by providing a sufficient adhesion to the respective fragments, which may thus substantially not contaminate the interior of the transport container or may at least significantly reduce any contamination compared to conventional strategies. Furthermore, the effect of the safety materials provided on the respective substrates may be enhanced by reducing the amount of external load on the substrate, for instance by appropriately positioning the substrates in the respective transport container. Furthermore, in illustrative embodiments, the application of the safety material may be associated with the provision of respective sensor elements in order to detect or at least temporarily monitor the transport conditions of the individual substrates. This enables efficient gathering and evaluating of the corresponding data, thereby enhancing the overall transport efficiency.

Thus, the subject matter disclosed herein is highly advantageous in the context of transporting substrates for the processing of microstructure devices from one manufacturing site to another over long distances, involving transport media, such as roads, air routes, sea routes and the like, since here highly variable and unpredictable transport conditions may occur. It should be appreciated, however, that the subject matter disclosed herein may also be applied to situations in which the respective manufacturing sites are located close to each other, while nevertheless requiring transport activities under sophisticated conditions, for instance when non-automated transport systems are involved, or generally when the probability for transport-induced losses is to be reduced.

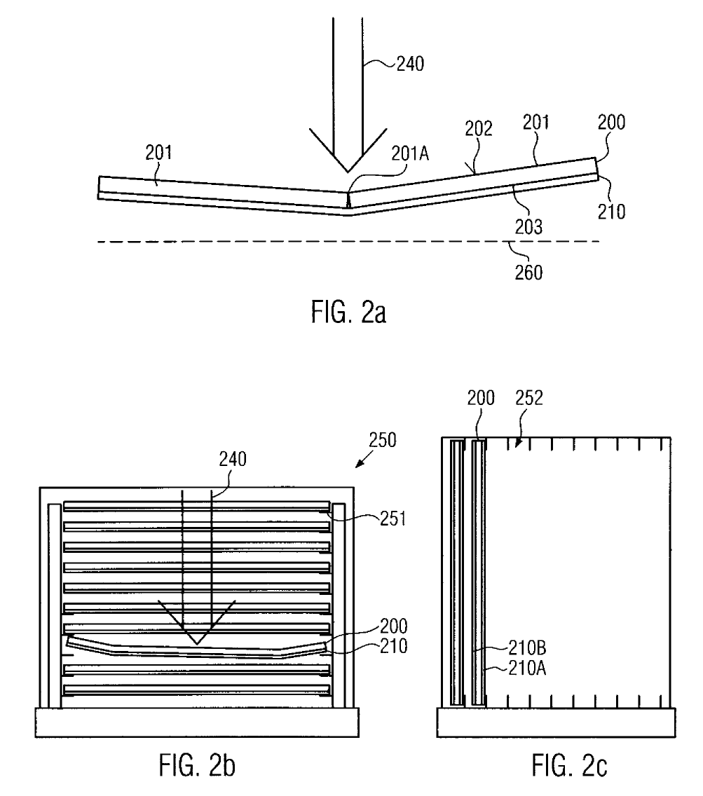

FIG. 2a schematically illustrates a substrate 200 when subjected to a specific stress condition, indicated as an external load 240, which may, depending on the internal characteristics of the substrate 200, create a severe damage such as a crack and the like. The substrate 200 may represent any appropriate carrier material for forming therein and thereon respective microstructure devices such as integrated circuits, micromechanical devices, optoelectronic devices and the like. For convenience, any such microstructure devices are not shown in FIG. 2a. In other cases, the substrates 200 may represent carrier materials that have to be provided to a manufacturer of microstructures. As previously explained, there is an ongoing drive to enhance the size of the individual substrate in order to increase the efficiency of the respective manufacturing processes. Hence, the number of individual devices formed on a single substrate 200 may also increase, which may result in a significant increased degree of yield loss when the substrate 200 may break upon the transport-induced stress condition 240. For example, a typical diameter of the substrate 200 may be 150-300 mm, wherein 450 mm may become a standard substrate size for the processing of silicon-based microstructure devices in the foreseeable future. The substrate 200 may have a front side 202 and a back side 203, wherein the front side 202 may be defined as the respective area of the substrate 200, which may receive therein and thereabove microstructure devices, such as integrated circuits and the like. It should be appreciated that the back side 203, which is typically used for handling the substrate 200 by automated transport systems and process tools, may also receive respective components, such as contact electrodes and the like, depending on the devices formed on and in the substrate 200. In other cases, the back side 203 may represent a material region of the substrate 200, which may be removed in a later process stage, depending on the device requirements. In any case, the front side 202 may represent a surface area of the substrate 200, which may receive and be the subject of most of the manufacturing processes for forming respective microstructure devices on the basis of the substrate 200. In one illustrative embodiment, the substrate 200 comprise, at least on the back side 203, an appropriate safety material 210 which may be configured to respond to the stress condition 240 such that the generation of loose fragments of the substrate 200 may be substantially reduced or even be substantially avoided when the substrate 200 may not withstand the stress condition 240. In some illustrative embodiments, the safety material 210 may represent a material having an increased flexibility compared to the substrate 200 so that the material 210 may substantially not tend to form respective cracks or other deformations which may jeopardize the mechanical integrity of the material 210, at least for a wide variety of external stresses 240. In one illustrative embodiment, the safety material 210 may comprise an adhesive layer which may reliably adhere to the back side 203 of the substrate 200, thereby substantially avoiding the separation of fragments of the substrate 200 when being destroyed. For instance, the adhesive layer representing or being a part of the safety material 210 may be provided in the form of a foil-like material providing sufficient adhesion to the back side 203 to hold back fragments. For example, appropriate polymer materials are available providing the desired degree of stability and adhesion. In one example, the corresponding safety material 210 may comprise a foil material as is used in a similar manner as a sawing foil used for separating individual dies in a later manufacturing stage. The safety material 210 may be applied to the back side 203 on the basis of any established process technique, such as spin-on techniques, chemical vapor deposition (CVD), wherein a subsequent treatment may optionally be performed in order to impart the desired characteristics to the base material previously applied. In other cases, the safety material 210 may be attached to the substrate 200 by a mechanical process when the base material for forming the safety material 210 may be provided with a foil-like consistency. Thereafter, further materials may be applied, as will be described in more detail later on.

During a typical transport situation, the stress 240 may act on the substrate 200, which may result, due to already existing internal mechanical stresses and the like, in a corresponding creation of a crack 201A, possibly resulting in forming respective fragments 210, which, however, adhere to the safety material 210, thereby substantially confining the fragments 210 to the safety material 210. It should be appreciated that, in the configuration shown in FIG. 2a, the substrate 200 is provided in a substantially horizontal orientation, wherein in this case the term “horizontal” is to be understood as an absolute position information, that is, the substrate 200 is substantially horizontally arranged with respect to ground 260. Consequently, providing the safety material 210 on the back side 203, at least to a certain degree, may stabilize the broken substrate 200 since the respective edges of the crack 201A may be forced against each other at the front side 202, while the respective edges at the back side 203 may be torn apart by gravity, wherein the resulting distance is substantially limited by the elasticity of the safety material 210. For a low elasticity, the safety material 210 may even substantially maintain the position of the substrate 200 even in its broken stage, except for a certain degree of curvature that depends on the degree of elasticity provided by the safety material 210, without requiring any further mechanical components.

FIG. 2b schematically illustrates a typical transport situation in which a transport container 250 may comprise a plurality of substrates, such as the substrates 200 as shown in FIG. 2a. In the case where the external stress 240 acts on the substrates, one of the substrates 200, as is indicated in FIG. 2b, may exceed the corresponding “threshold” and a respective crack 210A may form wherein, however, the separation of any fragments 201 from the involved substrate 200 and into the interior of the transport container 250 may be substantially avoided or the number of liberated portions of the substrate 200 may at least be significantly reduced compared to conventional strategies without the safety material 210. In situations as described above with reference to FIG. 2a, the broken substrate 200 may even maintain its position within the respective compartment, wherein the degree of bending of the substrate 200 may depend on the degree of destruction of the substrate 200 and the characteristics of the safety material 210. For example, for a material with a moderately low degree of elasticity, the resulting curvature after the breakage of the substrate 200 may be less compared to the distance to the lower lying adjacent substrate 200 in the container 250, thereby substantially avoiding undue contact of the broken substrate 200 with the lower lying neighboring substrate. In other cases, when a certain degree of material removal may occur at the front side 202 of the substrate 200, for instance by releasing from the respective edge of the crack 201A during the external stress 240, the curvature and thus bending of the broken substrate 200 may be increased, which may possibly result in contacting the lower lying substrate, however at a reduced tendency for damaging the neighboring substrate, while nevertheless a separation of larger fragments 201 may be efficiently suppressed by the safety material 210. In other illustrative embodiments, a significant material delamination at the front side 202 may be suppressed by providing a respective protective film thereon, as will be described later on in more detail.

It should be appreciated that, in the transport regime shown in FIG. 2b, the substrates 200 are arranged substantially horizontally with respect to ground, thereby providing the potential for using conventional transport regimes, however with a significantly reduced probability for transportation-induced container contamination and thus yield loss. However, as previously explained, the respective substrates 200 are substantially supported at the periphery thereof by a respective support structure 251, which may result in a significant mechanical stress within central areas of the respective substrates 200 caused by gravity, in particular when substrates of increased diameter are considered. That is, the respective substrate 200 may suffer from a significant mechanical stress resulting in a certain degree of tensile deformation at the back side 203 and a compressive deformation at the front side 202. Consequently, for substrates of increased diameter, any mechanical or other externally induced stress, such as the stress 240, may result in lowering the respective “threshold” or “tolerance level for external loads” with respect to wafer breakage, creating a moderately high risk for substrate breakage even for moderately low external stress levels. Hence, in a corresponding situation, the provision of the safety material 210 may significantly reduce a potential yield loss in conventional transport regimes. In other illustrative embodiments, in addition to the safety material 210, the self stability of the substrate 200 may be enhanced by selecting a different orientation during the transport of the substrates 200.

FIG. 2c schematically illustrates the situation of transport of the substrate 200 in a respectively configured transport container 250, in which respective compartments 252 are arranged in a non-horizontal manner. In the illustrative embodiments shown, the corresponding compartments 252 are configured to receive the substrates 200 in a substantially vertical orientation so that gravity-induced tensile and compressive stresses of the substrate 200 may be significantly reduced. Thus, in combination with the safety material 210, the probability for creating stress levels causing the breakage of substrates may be reduced, while additionally any contamination caused by broken substrates may also be reduced, thereby in total resulting in a significantly enhanced transport efficiency. In some illustrative embodiments, as shown in FIG. 2c, the respective substrates 200 may have formed thereon the safety material 210 in the form of a first portion 210A provided on the back side and a second portion 210B provided on the front side, wherein the first and second portions 210A, 210B may have substantially the same material composition or may differ in at least one characteristic, depending on the process requirements. For instance, the safety material 210A provided at the back side 203 may provide the high mechanical integrity and the adhesion characteristics, while the material 210B provided on the front side 202 may significantly reduce the delamination of minute particles from areas in which respective cracks 201A may form. In this manner, the efficiency of the material 210A may be enhanced and at the same time any substrate internal contamination by particles may also be suppressed. Hence, respective fragments 201, which are big enough for containing one or more intact devices, may even further be used for further processing, for instance for the separating of individual die areas, even after a breakage of the respective substrate. Moreover, by providing the respective material 210B on the front side 202, any other contamination related to substrate handling and transport activities may be significantly reduced, thereby further contributing to an increased overall production yield.

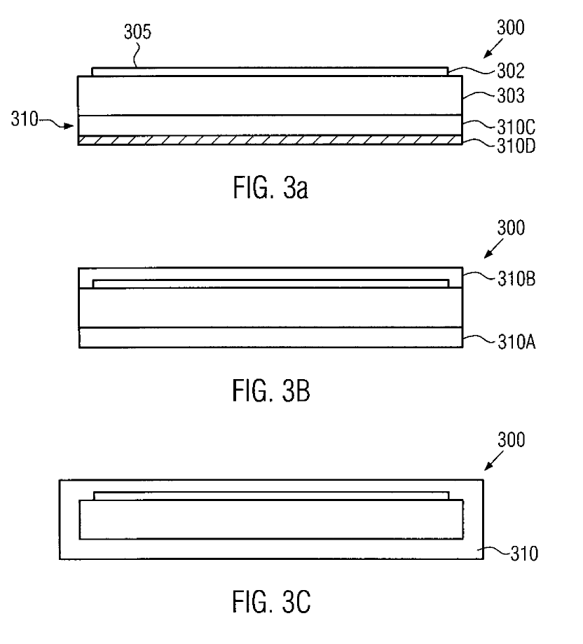

It should be appreciated that a corresponding protective front side material and the like may also be provided in the transport regime as described with reference to FIGS. 2a and 2b, wherein respective strategies will be described later on in more detail when referring to FIGS. 3a-3c.

In still other illustrative embodiments (not shown), the orientation of the substrates 200 may be selected at any appropriate angle between the substantially horizontal orientation, as shown in FIG. 2b, and the substantially vertical orientation as shown in FIG. 2c. In this case, the corresponding degree of increasing the self-stability of the substrates 200 may be adjusted to a desired degree, for instance by using an angle of approximately 40-60 degrees with respect to ground, while nevertheless substantially ensuring a certain amount of gravity acting on a broken substrate 200 so as to generate a gravity-induced bending of the broken substrate, thereby providing a certain degree of self-stability even after the breakage of the respective substrate.

FIG. 3a schematically illustrates a substrate 300 comprising a front side 302 and a back side 303. The substrate 300 may represent a substrate, as previously described with respect to the substrates 100 and 200. Furthermore, in the embodiment illustrated, the substrate 300 may comprise in and above its front side 302 an “active” area 305, in which respective microstructure devices, such as integrated circuits and the like, may be provided. The respective microstructure devices in the area 305 may be in an advanced manufacturing stage, for instance the area 305 may include substantially completed integrated circuits requiring the separation of individual die and the attachment to an appropriate package. Moreover, the substrate 300 may comprise on its back side 303 a respective safety material 310 in order to prepare the substrate 300 for a subsequent transport activity. In one illustrative embodiment, the safety material 310 may comprise a first layer of material 310C providing at least the required degree of adhesion to the back side 303 of the substrate 300. That is, the material 310C may adhere to the back side 303 even if the substrate 300 is broken into a plurality of individual fragments due to the interaction of a typical transport-related external stress. It should be appreciated that a transport-related external stress is to be considered as any external influence of a certain amount, which may result in the destruction of the respective substrate 300, while other substrates may stay intact. For example, the material 310C may represent any appropriate material providing the desired degree of adhesion, wherein it may also have a certain degree of mechanical stability and flexibility for responding to any external stress. In order to further enhance the desired safety characteristics of the material 310, at least one further material layer 310D may be provided, which may endow the material 310C with an increased mechanical stability. For instance, the stiffness of the material 310C may be significantly enhanced by providing an appropriate material, such as a metal layer and the like, which may impart the required characteristics. In other cases, the layer 310D may be comprised of a metal grid, which may include respective portions of a metal material having a high degree of tenacity, thereby enhancing the overall stability characteristics of the safety material 310. It should be appreciated that the material layers 310C, 310D may be provided in the form of a layer stack, as shown, while, in other illustrative embodiments, these materials may be provided in an “integrated” form, for instance when a respective metal grid may be incorporated into the material of the layer 310C. Furthermore, the safety material 310 may comprise additional material layers, for instance a further layer of material 310C in order to encapsulate the material 310D having the increased mechanical stability. For example, the layer 310C may be provided in the form of a polymer material, such as a PVC material, followed by a metal-containing material for the layer 310D, which may optionally be followed by a further material, such as a polymer and the like.

The substrate 300 as shown in FIG. 3a may be formed by processing the substrate 300 without the safety material 310 on the basis of any appropriate process sequence for forming the respective microstructure devices in the area 305. At any appropriate manufacturing stage, the safety material 310 may be applied, wherein, in some illustrative embodiments, the respective material layers 310C, 310D may be provided individually, for instance by appropriate deposition techniques, while, in other cases, some of the sub-layers of the material 310 may be formed separately from the substrate 300 and may be subsequently applied to the substrate 300. For example, if the safety material 310 may exhibit substantially foil-like characteristics, i.e., it may be flexible and have a high degree of tenacity, wherein the degree of elasticity may be, for instance, adjusted on the basis of the material 310D, the safety material 310 may be applied in a mechanical process wherein, for instance, appropriately dimensioned pieces of the material 310 may be attached to the back side 303. In other cases, a portion of the material 310 may be attached by mechanical techniques followed by the deposition of an appropriate material for adjusting the desired characteristics. If required, the corresponding process sequence may be reversed, i.e., any appropriate material such as an adhesive may be applied by a deposition technique, such as spin-on, CVD and the like, followed by the mechanical attachment of a further material, such as the layer 310D.

After applying the safety material 310, the substrate 300 may further be processed if the material 310 may be compatible with subsequent process steps, or the substrate 300 may be inserted into a respective transport container, as previously described.

FIG. 3b schematically illustrates the substrate 300 according to further illustrative embodiments. Here, a safety material 310A may be provided on the back side 303 while additionally a further safety material 310B may be provided on the front side 302, thereby also covering the area 305. The material 310B may represent a protective film of any appropriate material composition, which may be selected so as to not unduly interact with any microstructure devices in the area 305, while nevertheless reliably suppressing contamination of the area 305. For example, the material 310B may be comprised of polymer material or may even exhibit foil-like characteristics, wherein, in some illustrative embodiments, the adhesion and mechanical characteristics may differ from those of the material 310A. For example, as previously explained, the substrates 300 may be positioned in a substantially horizontal orientation within the respective transport containers so that the required mechanical stability within the container may be provided by the material 310A when the substrate 300 may break during transport. In this case, the material 310B may significantly suppress the delamination of any material, in particular in the vicinity of crack areas, which may otherwise result in a particle contamination of other substrates contained in the same transport container. In other illustrative embodiments, the material 310B may have similar characteristics compared to the safety material as previously described with respect to the substrates 200 and 300 in FIG. 3a, thereby further reducing the probability of container contamination upon breakage. In other cases, as previously described with respect to FIG. 2c, a corresponding high degree of mechanical stability of the respective safety material may be advantageous on both sides of the substrate 300, when positioned in a substantially vertical orientation. In this case, the form and position of the substrate 300 may be substantially maintained, irrespective of the vertical orientation of the substrate 300. With respect to forming the safety materials 310A, 310B, the same criteria apply as previously explained with respect to the materials 210 and 310C and 310D. That is, each of the materials 310B, 310A may itself be comprised of different materials and/or layers in order to provide the desired characteristics, as previously explained.

FIG. 3c schematically illustrates the substrate 300 according to further illustrative embodiments in which the substrate 300 may be substantially encapsulated by the corresponding safety material 310. In this case, the safety material 310 may substantially act as a cladding for the substrate 300, wherein the safety material 310 may, in some illustrative embodiments, have a sufficient self-stability in order to maintain its size and shape even after breakage of the substrate 300. In other cases, the safety material 310 may act as a buffer material, which may significantly reduce the effective amount of thermal and/or mechanical stress actually acting on the substrate 300, thereby further reducing the probability of wafer breakage. In addition, even if the corresponding “threshold for breakage” may be exceeded, the encapsulation by the material 310 may suppress the migration of even tiny particles to the exterior of the safety material 310.

The safety material 310 as shown in FIG. 3c may be formed on the basis of any appropriate technique, such as immersing the substrate 300 in an appropriate precursor material and performing a respective post treatment in order to adjust the final characteristics of the material 310. For instance, respective polymer materials may be efficiently cured on the basis of UV radiation, heat and the like. As previously explained with reference to FIG. 3a, the mechanical characteristics may be adjusted by providing different materials, at least locally, within the material 310 if required. In other cases, the treatment of the material 310 after application may be controlled such that the material characteristics may vary over thickness of the material 310. For example, curing the material 310 after application may be controlled such that a moderately sticky state may be maintained at the vicinity of the respective surfaces 302, 303, while the outer surface portions of the material 310 may provide the desired mechanical stability.

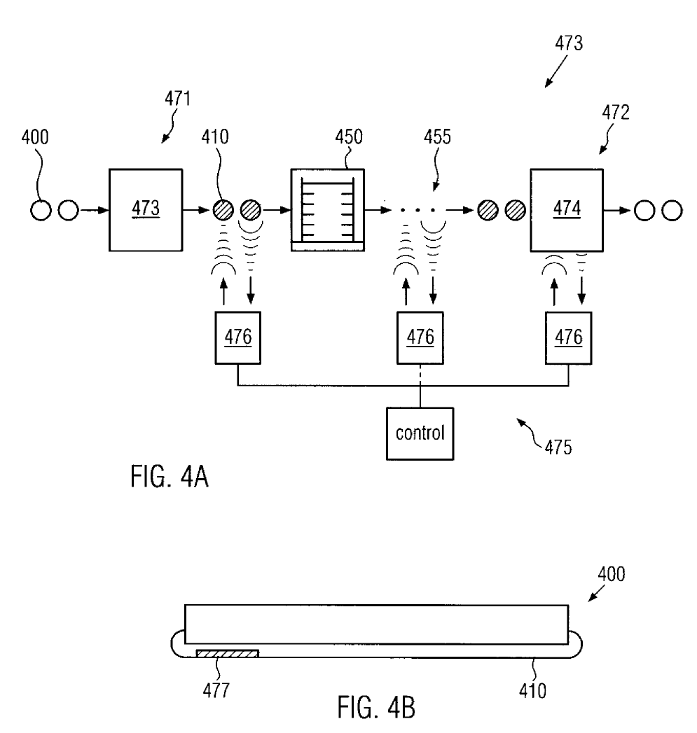

FIG. 4a schematically illustrates a system 470 for shipping substrates or transporting substrates used or usable for the processing of microstructures from a first manufacturing site 471 to a second manufacturing site 472. The respective manufacturing sites 471, 472 may represent respective facilities for performing a manufacturing sequence, for instance producing semiconductor devices up to a specified manufacturing stage, while a subsequent manufacturing sequence may then be performed in a different location. The system 470 may comprise a respective process tool 473 located in the first manufacturing site 471 in order to provide respective substrates with a safety material 410 which may have characteristics as previously described with respect to the materials 210, 310. Furthermore, the system 470 may be configured to insert the substrates 400 having the safety material 410 into appropriate transport containers 450 in order to convey the substrates 400 via respective transport media 455 to the second manufacturing site 472. In one illustrative embodiment, the system 470 may comprise a respective process tool 474 configured to receive the substrates 400 and to remove the corresponding safety material 410 prior to actually further processing the substrates 400. As previously explained, the respective safety material 410 may be formed on the basis of various process techniques and may include different materials so that the corresponding process tools 473 and 474 may be configured to provide and appropriately remove the corresponding safety material 410. Thus, the process tool 473 may comprise mechanical attachment tools, deposition tools, spin-on tools and the like, depending on the characteristics of the safety material 410. Similarly, the process tool 474 may comprise respective tools for mechanically detaching the material 410 and may comprise respective etch tools and the like. In still other illustrative embodiments, the safety material 410 or at least portions thereof may be maintained if the corresponding material characteristics of the remaining material portions are compatible with the process steps to be performed in the second manufacturing site 472.

In one illustrative embodiment, the system 470 may comprise a monitoring system 475 that is configured to monitor or detect at least one parameter related to the transport conditions in the transport media 455. In one illustrative embodiment, the safety material 410 may be associated with a corresponding sensor characteristic in order to enable the detection of an appropriate parameter value that may be collected by the monitoring system 475. In one illustrative embodiment, the safety material 410 may have incorporated or attached thereto a respective sensor element that may be accessed wirelessly in order to obtain information about the transport condition in the media 455. For this purpose, radio frequency controlled and activated devices may be used, which may incorporate a sensor portion for assessing respective transport conditions, such as temperature, humidity, mechanical stress and the like. Respective measurement data may be collected by one or more receiver units 476, which may be positioned at any appropriate location in order to obtain the desired information. For instance, a receiver unit 476 may be positioned at the second measurement site 472 in order to assess the transport conditions on the basis of information provided by the respective sensor elements. In other cases, a plurality of receiver units 476 may be provided in order to obtain more detailed information with respect to the transport situation for the respective substrates 400. For example, if respective sensor elements associated with the safety material 410 may allow access by radio frequency signals, corresponding measurement information may be gathered at any desired location within the entire transport route. For example, respective RF IDs or smart labels may be fabricated with extremely low volume, so that the corresponding elements may readily be attached to the safety material 410 without requiring any reconfiguration of already existing transport containers or any other transport related equipment. For example, respective elements may readily be attached or incorporated into foil-like materials, which may then be used as the safety material 410. Since many of these sensor elements may be operated without requiring an internal supply voltage, a high degree of flexibility may be obtained with respect to using and accessing the respective sensor elements.

FIG. 4b schematically illustrates the substrate 400 according to one exemplary embodiment wherein the safety material 410 may have incorporated therein a respective sensor element 477. In some illustrative embodiments, the element 477 may represent an electronic device, which may respond to radio frequency signals, wherein the corresponding response may depend on at least one transport-related parameter, such as pressure, stress, temperature and the like. In other illustrative examples, the sensor element 477 may represent a non-electronic portion of the safety material 410, which may act as an indicator material in order to indicate a status of at least one transport-related parameter, such as temperature, humidity and the like. For example, the sensor element 477 may indicate a maximum temperature or a minimum temperature, or both, to which the device 477 was exposed during the transport.

As a result, the subject matter disclosed herein addresses the problem of transport-related contamination problems caused by the breakage of substrates in a transport container in that the respective substrates are prepared for transport by providing a respective safety material, which may significantly reduce the probability for creating loose fragments and particles, when a corresponding substrate may break due to the respective transport conditions. For this purpose, at least a portion of the surface of the substrate is covered by the safety material, which may confine any fragments and may also impart an improved protection against surface contamination. Furthermore, by appropriately positioning the substrates in the transport container, the probability of substrate breakage may be reduced which, in combination, with the provision of a respective safety material, may even further reduce any yield loss caused by substrate transport, especially if substantially fully processed micro-structure substrates are considered.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
transporting a substrate in a transport container from a first manufacturing site to a second manufacturing site, said substrate having a front side and a back side and representing a carrier material for forming microstructure devices in and on said front side; and
applying an adhesion layer on the back side of said substrate prior to transporting said substrate, said adhesion layer being configured to reduce contamination of said transport container upon transport-related break of said substrate.

2. The method of claim 1, wherein said substrate is oriented in a substantially horizontal direction relative to ground during transport with said back side facing downwards.

3. The method of claim 1, wherein said substrate is positioned in an oblique orientation relative to ground for reducing a lateral power acting on said substrate during transport.

4. The method of claim 1, further comprising applying a protective film above said front side.

5. The method of claim 4, wherein said protective film is configured to reduce contamination of said transport container upon transport-related break of said substrate.

6. The method of claim 5, wherein said substrate is oriented in a substantially vertical orientation relative to ground so as to reduce a lateral power acting on said substrate during transport.

7. The method of claim 1, wherein applying said adhesion layer comprises forming a flexible material layer on said back side, said flexible material layer having a sticky surface in contact with said back side.

8. The method of claim 7, wherein a stability of said adhesion layer is increased by forming a reinforcement layer on said flexible material layer.

9. The method of claim 1, further comprising receiving said transport container at said second manufacturing site and removing said adhesion layer.

10. The method of claim 1, further comprising providing a detector system attached to said adhesion layer and determining at least one parameter for evaluating transportation conditions of said substrate.

11. The method of claim 1, wherein at least one further substrate is transported in said transport container, said at least one further substrate having on a back side thereof a further adhesion layer configured to reduce contamination of said transport container upon transport-related break of said at least one further substrate.

12. A method, comprising:
forming a safety material on a substrate used for processing microstructure devices, said safety material configured to reduce formation of loose fragments upon break of said substrate; and
conveying said substrate from a first manufacturing site to a second manufacturing site.

13. The method of claim 12, wherein said substrate is conveyed in a substantially horizontal orientation relative to ground and said safety material is provided as a flexible adhesive material layer facing downwards.

14. The method of claim 12, wherein said substrate is conveyed in a substantially vertical orientation relative to ground to increase self-stability of said substrate with respect to a lateral power during transport.

15. The method of claim 12, wherein forming said safety material comprises forming an adhesive material on at least one of a back side and a front side of said substrate, said adhesive material having a higher degree of flexibility compared to said substrate.

16. The method of claim 12, wherein forming said safety material comprises substantially encapsulating said substrate.

17. The method of claim 12, further comprising at least partially removing said safety material at said second manufacturing site and continuing processing said substrate.

18. The method of claim 12, wherein forming said safety material comprises forming a foil material at least on one side of said substrate.

19. The method of claim 12, further comprising monitoring at least one transport parameter when conveying said substrate from the first manufacturing site to the second manufacturing site.

20. A system for shipping substrates of microstructure devices from a first manufacturing site to a second manufacturing site, comprising:
a load station configured to load one or more substrates into a transport container, said one or more substrates comprising a safety material adapted to reduce contamination of said transport container upon break of said one or more substrates; and
a process tool configured to form said safety material on each of said one or more substrates.

21. The system of claim 20, further comprising a monitoring system configured to monitor at least one transport parameter indicating the transport status of each of said one or more substrates.

22. The system of claim 21, wherein said monitoring system comprises a sensor element associated with said safety material.
